(19) United States
(12) Patent Application Publication
(10) Pub. No.: US 2013/0181125 A1
(43) Pub. Date: Jul. 18, 2013

(54) METHOD AND SYSTEM FOR INCREASING THE DYNAMIC RANGE OF ION DETECTORS

(71) Applicants: Mircea Guna, Toronto (CA); Bruce Collings, Bradford (CA)

(72) Inventors: Mircea Guna, Toronto (CA); Bruce Collings, Bradford (CA)

(73) Assignee: DH TECHNOLOGIES DEVELOPMENT PTE. LTD., UOB Plaza (SG)

(21) Appl. No.: 13/817,189

(22) PCT Filed: Aug. 18, 2011
(86) PCT No.: PCT/IB2011/001905

§ 371 Date: Mar. 22, 2013

Related U.S. Application Data
(60) Provisional application No. 61/375,132, filed on Aug. 19, 2010.

(51) Int. Cl. H01J 49/00; H01J 49/06

(52) U.S. Cl. CPC H01J 49/0031; H01J 49/06
USPC 250/282; 250/281

(57) ABSTRACT

A mass spectrometer system can include a mass analyzer operable to mass transmit streams of ions to a detector in a mass dependent fashion for measurement of ion flux intensity. An ion attenuator can be located in the extraction region between the mass analyzer and detector, downstream of the mass analyzer, and can be operable to provide selective attenuation of the ion beam by attenuating ion flux intensity also in mass dependent fashion. Higher concentration ions can be selected and attenuated, while other lower concentration ions can be left unattenuated. Different ions can be attenuated to different degrees. Locating the ion attenuator downstream of the mass analyzer so that the ion beam is already mass differentiated when attenuated can avoid mass discriminatory effects associated with ion beam attenuators. Selective attenuation of only certain ions but not others can extend the dynamic range of the detector without necessarily sacrificing detector sensitivity.

### FIELD

Embodiments of the present invention relate to mass spectrometers, and more particularly to mass spectrometers having extended dynamic range and methods of operating the same.

### INTRODUCTION

Mass spectrometry (MS) is an analytical technique for determining the elemental composition of test substances that has both quantitative and qualitative applications. For example, MS can be useful for identifying unknown compounds, determining the isotopic composition of elements in a molecule, and determining the structure of a particular compound by observing its fragmentation, as well as for quantifying the amount of a particular compound in the sample.

Mass spectrometry can operate by ionizing a sample of the test substance using one of many different available methods to form a stream of positively charged particles, i.e. an ion beam. A downstream mass analyzer can then subject the ion beam to mass differentiation (in time and/or space) to separate different particle populations in the ion beam according to mass-to-charge (m/z) ratio for detection by an ion detector. Intensities of the mass-differentiated particle populations can be determined in order to compute analytical data of interest, e.g. the relative concentrations of the different particle populations, mass-to-charge ratios of product or fragment ions, but also other potentially useful analytical data.

### SUMMARY

In accordance with one broad aspect, certain embodiments of the present invention relate to a method of operating a mass spectrometer system. According to the method, a plurality of kinds of ions of different mass to charge ratios is provided in an upstream mass analyzer. The plurality of kinds of ions is transmitted from the upstream mass analyzer to a detector by transmitting each kind of ions in the plurality of kinds of ions as a stream of that kind of ions. The plurality of kinds of ions is detected at the detector to generate a plurality of detection signals, which comprises an associated detection signal for each kind of ions in the plurality of kinds of ions. For at least one kind of ions in the plurality of kinds of ions, the associated detection signal for that kind of ions is attenuated by an attenuation factor by attenuating the stream of that kind of ions from the upstream mass analyzer to the detector to reduce a number of ions of that kind of ions reaching the detector by the attenuation factor.

In accordance with another broad aspect, certain embodiments of the present invention relate to a mass spectrometer system. In the mass spectrometer system, an upstream mass analyzer receives a plurality of kinds of ions of different mass to charge ratios and is operable to transmit each kind of ion in the plurality of kinds of ions from the upstream mass spectrometer as a stream of that kind of ions for detection. A detector detects the plurality of kinds of ions transmitted from the upstream mass analyzer to generate a plurality of detection signals, which comprises an associated detection signal for each kind of ions in the plurality of kinds of ions. An ion attenuator located downstream of the upstream mass analyzer is operable to, for at least one kind of ion in the plurality of kinds of ions, attenuate the associated detection signal for that kind of ions by an attenuation factor by receiving and attenuating the stream of that kind of ions from the upstream mass analyzer to the detector to reduce a number of ions of that kind of ions reaching the detector by the attenuation factor.

These and other features of the embodiments as will be apparent are set forth and described herein.

### BRIEF DESCRIPTION OF THE DRAWINGS

A detailed description of various embodiments is provided herein below with reference, by way of example, to the following drawings.

FIG. 1, in a schematic diagram, illustrates an approach to providing ion beam attenuation in a mass spectrometer.

FIG. 2A, in a schematic diagram, illustrates mass discriminatory effects introduced by the approach to providing ion beam attenuation shown in FIG. 1.

FIG. 2B, in a schematic diagram, illustrates mass discriminatory effects introduced by the approach to providing ion beam attenuation shown in FIG. 1.

FIG. 3, in a schematic diagram, illustrates a mass spectrometer system utilizing selective ion beam attenuation to extend dynamic range, according to aspects of embodiments of the present invention.

FIG. 4, in a schematic diagram, illustrates an axial view of the set of auxiliary electrodes in the mass spectrometer system shown in FIG. 3.

FIG. 5A, in a timing diagram, illustrates an aspect of selective ion beam attenuation using the mass spectrometer system shown in FIG. 3.

FIG. 5B, in a timing diagram, illustrates another aspect of selective ion beam attenuation using the mass spectrometer system shown in FIG. 3.

FIG. 6, in a graph, illustrates a mass chromatogram generated with and without ion beam attenuation.

It will be understood that the drawings are exemplary only and that all reference to the drawings is made for the purpose of illustration only, and is not intended to limit the scope of the embodiments described herein below in any way. For convenience, reference numerals may also be repeated (with or without an offset) throughout the figures to indicate analogous components or features.

### DETAILED DESCRIPTION OF EMBODIMENTS

It will be appreciated that for clarity, the following discussion will explicate various aspects of embodiments of the invention, but omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the invention may not require certain of the specifically described details in every implementation, which are set forth herein only to provide a thorough understanding of the embodiments. Similarly it will be apparent that the described embodiments may be susceptible to slight alteration or variation according to common general knowledge without departing from the scope of the disclosure. The following detailed description of embodiments is not to be regarded as limiting the scope of the present invention in any manner.

The limited dynamic range of some ion detectors can pose a substantial constraint on the performance of high sensitivity mass spectrometers. Dynamic range refers to the detector's measurable range of ion intensities. Sensitivity is related to the lowest concentration of ions that the detector can accurately detect. For present mass spectrometer applications, ion sensitivities of as low as a few ppm can be targeted. The constituent ion populations in many test substances, however, can have widely varying relative concentrations. An ion detector with a large dynamic range can therefore be required for accurate measurement of both the low concentration and high concentration ion populations. As brighter and more efficient ion sources become available, ion detectors can be pushed beyond their normal operating range in terms of detectable ion intensities, which can place considerable strain on the performance of the ion detector over time. Sustained operation of the ion detector beyond its rated limits can also significantly diminish the dynamic range of the instrument as well as shorten its overall useful lifetime.

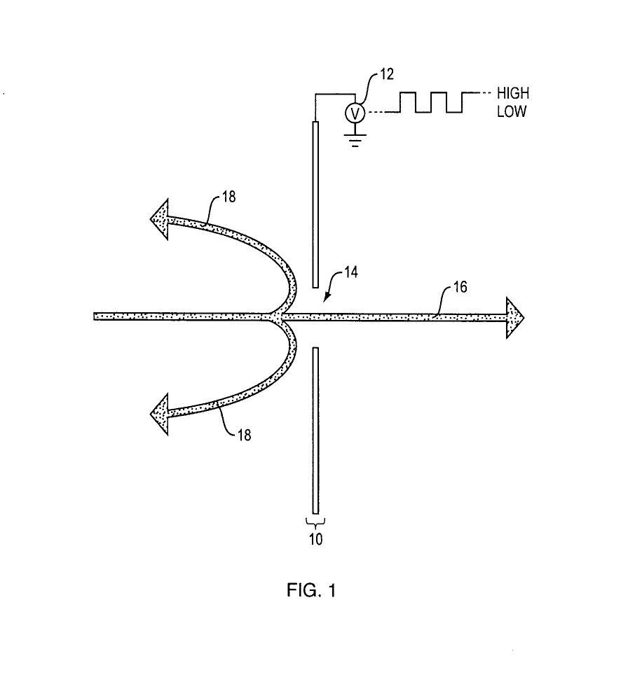

Referring initially to FIG. 1, there is illustrated one approach to extending the dynamic range of the ion detectors involving application of a time-varying voltage to one or more ion optical elements included in the mass spectrometer. The ion lens 10 is provided with a time varying voltage from voltage source 12, which can be a square wave pulse train. When the instantaneous voltage applied to the ion lens 10 is at a “low” voltage level, for example ground potential, the aperture 14 can transmit ions (indicated by transmission arrow 16) through to downstream components. However, when the instantaneous voltage applied to the ion lens 10 is at a “high” voltage level, a fringing field formed in the vicinity of the aperture 14 can present an effective barrier to ions, thereby limiting or preventing transmission through the aperture 14 altogether (indicated by deflection arrows 18). By alternating the voltage applied to the ion lens 10 between the high and low states, the ion lens 10 can be converted into a controllable barrier for ions.

Assuming a continuous (or at least pseudo-continuous) flow of ions, the transmissivity of the ion lens 10 can be controlled roughly proportional to the duty cycle of the applied pulse train. During time intervals when the applied voltage is at the low level, the aperture 14 can be open to all or nearly all of the ions in the incident beam. In contrast, during time intervals when the applied voltage is the high level, thereby forming the fringing field, the aperture 14 can be effectively closed to all or nearly all of the ions in the incident beam. Ions deflected by the fringing field can be destabilized and undergo orbital decay. If the incoming ion flux is roughly constant (which would be a reasonable assumption for a continuous or near continuous ion beam transmitted in a good and largely field free vacuum), then the overall transmissivity of the ion lens 10 can approximately equal the duty cycle of the applied pulse train. In other words, the percentage of ions transmitted by the aperture 14 can approximately equal the percentage of time the voltage applied to the lens 10 is at the low voltage level and the aperture 14 is thereby open to ions.

As the number of ions transmitted through the aperture 14 in lens 10 is reduced, the transmitted ion beam can have an intensity that is attenuated relative to the incident ion beam. The attenuation factor can be related the duty cycle of the applied pulse train, i.e., the intensity of the attenuated beam can approximately equal the intensity of the incident beam scaled by the duty cycle. Depending on how these two quantities are defined, therefore, the attenuation factor can equal the inverse of the duty cycle. Using final intensity measurements (i.e., of the attenuated ion beam) generated by the detector and knowledge of the attenuation factor, an initial intensity of the ion beam that is incident on the lens 10 can be reconstructed. By detecting an attenuated as opposed to full strength ion beam, ion intensities above an upper intensity detection threshold of the detector can be computed, thereby effectively raising the upper intensity threshold of the detector and increasing the dynamic range of the detector. Certain limitations are however associated with this approach, as will now be described.

One associated limitation is that ion beam attenuation, while increasing the effective upper intensity threshold of the detector, can also decrease the effective lower intensity threshold of the detector at the same time. Ion detectors can have a sensitivity limit that reflects the lowest concentration of ions that can be detected and distinguished from noise, for example. Attenuating the ion beam upstream of the mass analyzer can result in uniform attenuation of the whole of the ion beam mass spectrum. If the attenuation factor has been selected to prevent some high concentration ions from driving the detector into saturation, the same attenuation factor when applied to other low concentration ions present in the ion beam may reduce the number of those low concentration ions to below the sensitivity limit of the detector. These low concentration ions in the attenuated ion beam could then appear indistinguishable from noise. Uniform mass spectral attenuation can therefore represent a tradeoff between increased dynamic range and reduced detector sensitivity and consequently may not be suitable for all high sensitivity applications.

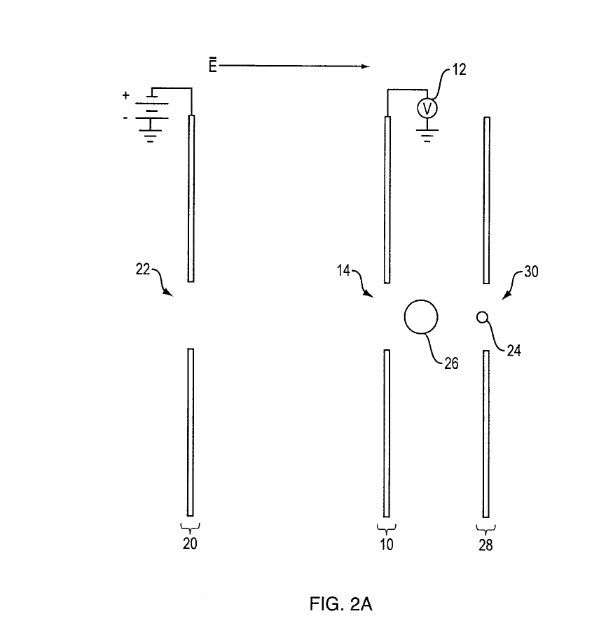

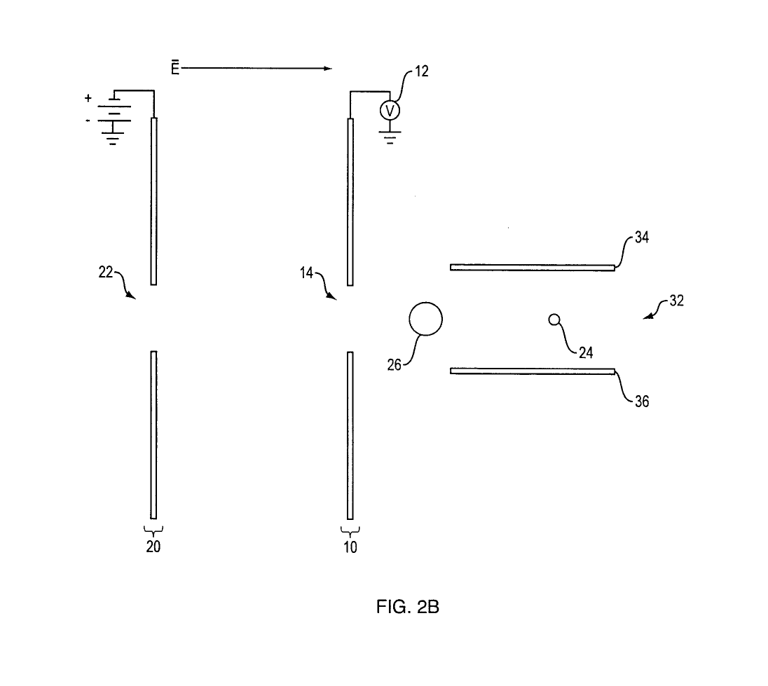

FIGS. 2A and 2B illustrate another potential limitation of utilizing lens pulsing to increase dynamic range, namely undesirable mass discrimination effects in the mass spectrometer. As before ion lens 10 is provided with a time varying voltage from the voltage source 12, which can be a square wave pulse train. The adjacent lens 20 can be maintained at an offset potential, which can be above the low voltage level of the pulse train applied to the ion lens 10. So long as the high voltage level is applied to the lens 10 to close the aperture 14, ions entering through aperture 22 can be trapped and start to amass in the region between the two lenses 10 and 20. When the applied pulse train drops to the low voltage level and the blocking field dissipates, a potential difference between the two lenses 10 and 20 can be created, resulting in the formation of an electric field (denoted E in FIG. 2A). The orientation of the electric field can depend on the polarity of the potential difference between the two lenses 10 and 20. In FIG. 2A it is assumed that the offset potential applied to the adjacent lens 20 is above the low voltage level of the pulse train to form an electric field having field lines in the direction of ion flow.

When the blocking field is dropped, ions trapped in the region between lenses 10 and 20 can experience an accelerative force in the presence of the electric field and thereby be imparted with kinetic energy (according to much the same principle of operation as time of flight mass spectrometry). The amount of kinetic energy imparted can be related to the charge of the ion and the potential difference, U, between the two lenses 10 and 20, according to:

$$zeU = \frac{1}{2} {mv}^{2} , \qquad ( 1 )$$

where e represents the elemental charge, z represents the number of elemental charges contained in the ion, m represents the mass of the ion, and v represents the particle velocity of the ion at the aperture 14. Rearranging Eq.1 to solve for velocity yields:

$$v = \sqrt{\frac{2 eU}{m / z}} , \qquad ( 2 )$$

It is clear from Eq.2 that the particle velocities of different ions at aperture 14 can depend, respectively, on the mass to charge (m/z) ratio of the ion. Ions having smaller m/z ratios can have higher particle velocities. Ions having larger m/z ratios can have lower particle velocities. In general, ions having different m/z ratios can have different particle velocities. The two ions 24 and 26 shown in FIG. 2A are assumed to have equal charges and masses of 10 Da and 1000 Da, respectively. If the space between the pulsed lens 10 and the downstream lens 28 is essentially field free, the lighter ion 24 can reach the downstream lens 28 ahead of the heavier ion 26. As an approximation, the flight time of the heavier ion 26 to reach the downstream lens 28 can be 10 times longer than the flight time of the lighter ion 24 (velocity is inversely proportional to the square root of m/z ratio according to Eq. 2). The act of applying the pulse train to ion lens 10 in order to attenuate the intensity of the incident ion beam can therefore cause axial spreading of ions of different m/z ratios and overall unbalance in the ion populations present in the ion beam. The ion populations can be unbalanced in the sense that the mass spectrum of ions may not be uniformly distributed throughout the axial length of ion beam by the time the ions reach the detector. Without correction lighter ions can tend to be time advanced relative to heavier ions.

Population unbalance can introduce inaccuracies and calibration difficulties into the mass spectrometer system. Any timed sequences in the operation of the mass spectrometer may be affected by the population unbalance. For example, it may be convenient to operate an ion trap in the mass spectrometer downstream of the lens 28. Ion traps have many different uses in mass spectrometry, such as increasing the overall duty cycle of the mass spectrometer, scanning mass analysis, and reducing space charge effects. In each such case, it may be important to precisely control the filling and/or emptying of the ion trap (e.g. by raising and lowering potential barriers applied to entry and exit lenses of the ion trap), which can become complicated if population unbalance has been introduced to the ion beam. Mass spectral accuracy can also be lessened as a result.

Space charge buildup is another potential source of calibration inaccuracy that can be introduced by lens pulsing. When the pulse train applied to the lens 10 is at the high voltage level, the resulting fringing field that forms around the aperture 14 presents an effective barrier to the incident ion flux (assuming that the incident ions have insufficient kinetic energy to penetrate the barrier). Deflection by the fringing field can cause a number of the incident ions to impact upon the surface of the ion lens 10. As more and more ions are impacted there may be a temporary build up of space charge in the vicinity of the aperture 12. As the built up space charge may not dissipate instantaneously, it can happen that some surface charge may remain on the lens 10 even after the applied voltage is dropped to the low voltage level. Until the built up space charge dissipates, a secondary fringing field may remain around the aperture 14 and, being of lesser magnitude generally than the primary fringing field, can pose a partial energy barrier for incident ions. Thus, even though the ion lens 10 has been set to full transmissivity, the ion lens 10 may yet have somewhat reduced transmissivity until the built up space charge has had time to dissipate (or until the pulse train is raised again the high voltage level to close the aperture 14). This is another potential source of error in the mass spectrometer when lens pulsing is employed as an ion beam attenuator.

FIG. 2B illustrates a related mass discriminatory effect as shown in FIG. 2A but for the particular case of a time-of-flight (TOF) mass spectrometer. As before, the ion lens 10 is provided with a time varying voltage, such as a square wave pulse train, from a suitable voltage source 12. Interaction between the pulsed ion lens 10 and the adjacent lens 20 results in the formation of an electric field in the intermediate region when the pulse train applied to lens 10 is dropped to the low voltage level (which is again assumed to be less than the offset potential at which lens 20 is maintained). Consequently when the blocking field is dropped, ions trapped in the intermediate region are accelerated by the electric field, E, to a particle velocity determined in accordance with Eq. 1. A suitable flight chamber for performing TOF is located downstream of the lens 10. As should be appreciated, TOF-MS can operate by establishing a very large amplitude and short duration pulse across the pusher plate 34 and puller plate 36 in order to push ions amassed in the accumulation region 32 through the flight tube toward a detector. When lens pulsing is employed for providing beam attenuation upstream of the flight tube, the resultant axial spreading can affect the accuracy and calibration of the TOF, as well as impose certain constraints its operation.

The particle velocity of the ions at aperture 14 as before can depend on m/z ratio resulting in unbalanced ion concentrations amassing in the accumulation region 32 of the flight tube. In particular, the lighter ion 24 can reach the accumulation region 32 ahead of the heavier ion 26. If ions are admitted into the TOF flight chamber in pulses, i.e. by voltage pulsing applied to the lens 10, the heavier ion 26 may not have adequate time to reach the acceleration region 32 before the TOF pulse is applied to the pusher and puller plates 34 and 46, in which case the heavier ion 26 would consequently be missing from the TOF mass spectrum. This could happen, for example, if the frequency of pulsing on the ion lens 10 is equal or near to the pulsing frequency of the acceleration voltage applied across the plates 34 and 36, with the result that the lighter ions 24 would consistently have sufficient time to amass in the acceleration region 32 when the heavier ion 26 would not. To avoid this mass discriminatory effect, the frequency of the TOF pulse can be made to be much slower, perhaps one or two orders of magnitude slower, than the frequency of the pulse train applied to the lens 10. Ion population unbalance can therefore impose a constraint on the extraction rate of the TOF flight chamber.

The ion population unbalance introduced by pulsing of the lens 10 can be compensated somewhat using a downstream collision cell or high pressure ion guide pumped with a suitable inert gas, such as helium or nitrogen. Collisions with the inert gas can cool down the ions and smear the energy and temporal profile of the ion pulses, effectively converting the pulsed ion beam into a quasi-continuous one.

Embodiments of the present invention described herein provide an alternative configuration of a mass spectrometer system that utilizes selective ion beam attenuation in order to increase detector dynamic range. In the described embodiments, ion beam attenuation is performed downstream of the mass analyzer after mass-differentiated streams of ions have been generated. As ion beam attenuation is performed on streams of different generally mass-differentiated kinds of ions, as opposed to a homogenized ion beam, no appreciable axial spreading occurs and the resulting mass discriminatory effects can be avoided or at least reduced. Additional degrees of control over the attenuation field can also be realized when attenuation is performed on mass-differentiated ions streams. For example, particular ions can be selected for attenuation, while transmitting other unselected ions to the detector with no attenuation of intensity. One selected kind of ion can also be attenuated to a different degree as another selected kind of ion. More generally, a different attenuation factor can be determined and applied to each different kind of ion present in numbers in the ion beam. The attenuation factor applied to a particular kind of ion can also be varied or modulated as required to ensure that the detector does not enter into saturation. Adjusted final intensity measures can then be computed using final intensity measures and corresponding attenuation factors in order to estimate initial ion intensities.

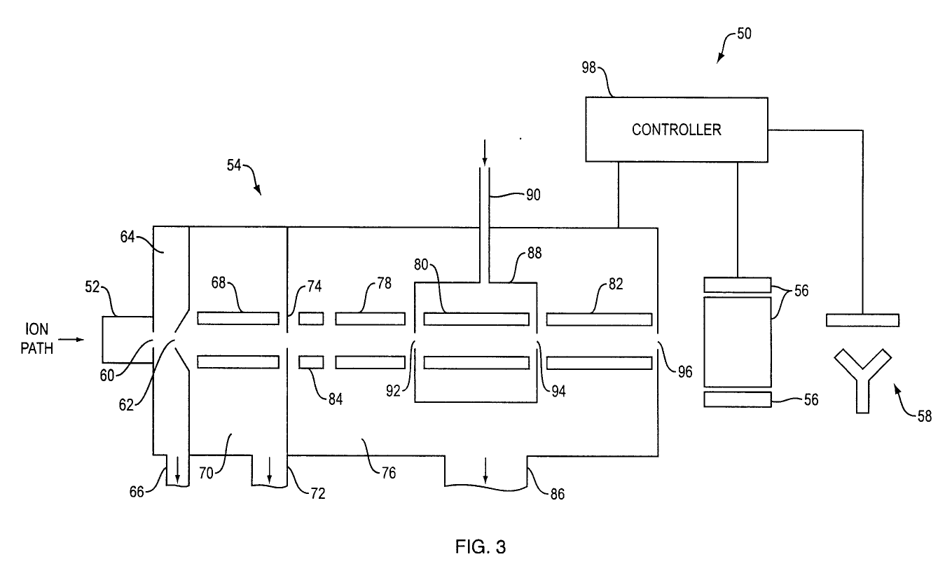

Referring now to FIG. 3, there is illustrated a mass spectrometer system 50, in accordance with aspects of embodiments of the present invention, which can be used to extend the dynamic range of an ion detector. It should be understood that mass spectrometer 50 represents only one possible MS configuration that may be utilized in embodiments of the present invention. As shown in FIG. 1, mass spectrometer 50 is a triple quadrupole mass spectrometer (QqQ). However, quadrupole ion trap topologies (QTrap, QqQTrap) can also be utilized in alternative embodiments of the present invention.

The mass spectrometer system 50 can comprise ion source 52, mass analyzer 54, auxiliary electrodes 56, and detector 58. Ion source 52 can be an electrospray ion source, but it should be understood that ion source 12 can be any other suitable ion source as well, such as an electron or chemical ionizer, an inductively coupled plasma (ICP) ion source, a matrix-assisted laser desorption/ionization (MALDI) ion source, a glow discharge ion source, and the like. Once emitted from the ion source 52, ions can be extracted into a coherent ion beam by passing successively through apertures in sampler plate 60 and skimming plate (“skimmer”) 62. The ion extraction provided by the sampler plate 60 and skimmer 62 can result in a narrow and highly focused ion beam. The skimmer 62 can be housed in a vacuum chamber 64 evacuated by mechanical pump 66 to a pressure of about 1-4 Torr, for example. In some embodiments, upon passing through the skimmer 62, the ions can enter into a secondary vacuum chamber (not shown) housing a secondary skimmer (not shown), and a second mechanical pump (not shown) can evacuate the secondary vacuum chamber to a lower pressure than the vacuum chamber 64. This arrangement can be utilized for example to provide additional focusing of and finer control over the ion beam.

Quadrupole 68 can be situated downstream of the skimmer 62 in vacuum chamber 70. Mechanical pump 72 can be operable to evacuate the vacuum chamber 70 to a pressure suitable for providing collisional cooling. For example, vacuum chamber 70 can be evacuated to a pressure of between 3-10 milliTorr, though other pressures are possible as well for this or for a different purpose. Quadrupole rod set 68 can be excited in RF-only mode to operate in conjunction with the pressure of vacuum chamber 70 as a collimating quadrupole. Lens 74 isolates vacuum chamber 70 from vacuum chamber 76 located downstream of vacuum chamber 70 in the mass analyzer 54.

Mass analytical quadrupoles 78, 80 and 82 housed in vacuum chamber 76 can be coupled with a power supply (not shown) to receive RF and/or DC voltages chosen to configure the quadrupoles 78, 80 and 82 for various different modes of operation depending on the particular MS application. Optional stubby rod set 84 can be situated intermediate the ion lens 74 and first mass analytical quadrupole 78 to facilitate the transfer of ions from the collimating quadrupole 68 to the mass analytical quadrupoles 78, 80 and 82. Stubby rod set 84 can help prevent ions from undergoing orbital decay due to interactions with any fringing fields that may have formed in the vicinity of ion lens 74, for example, if the ion lens 74 is maintained at an offset potential as can be the case. Mechanical pump 86 (which can be a turbo-molecular pump) can be used to evacuate the vacuum chamber 76 to pressures appropriate for performing mass analysis, which can typically be much lower than the pressure at which vacuum chambers 64 and 70 are maintained. A pressure of about 0.4×10⁻⁵ Torr to 8×10⁻⁵ Torr could be appropriate for vacuum chamber 76.

First mass analytical quadrupole 78 can be provided with RF/DC voltages suitable for operation in a mass-resolving mode. As should be appreciated, taking the physical and electrical properties of the quadrupole 78 into account, parameters for an applied RF and DC voltage can be selected so that the quadrupole 78 establishes a quadrupolar field having an m/z passband. Ions having m/z ratios falling within the passband can traverse the quadrupolar field largely unperturbed. Ions having m/z ratios falling outside the pass band, however, can be degenerated by the quadrupolar field into orbital decay and thus prevented from traversing the quadrupole 78. It should be appreciated that this mode of operation is but one possible mode of operation for the quadrupole 78, which could also be operated as an ion trap, for example.

Second mass analytical quadrupole 80 can be housed inside pressurized cell 88. The pressurized cell 88 can be operated as a collision chamber by pumping in a suitable inert collision gas (e.g., helium) by way of gas inlet 90. As described above, one possible purpose for the inert collision gas is to thermalize the ions in the ion beam.

Alternatively, by maintaining the entry lens 92 of the pressurized cell 88 at a much higher offset potential then the quadrupole 78, thereby converting quadrupole 78 into an ion trap, and then lowering the potential applied to the entry lens 92, ions can be accelerated into the pressurized cell 88 and therein be subjected to collision-induced dissociation (CID) or some other form of ion fragmentation. Alternatively, a suitable reactive gas can be pumped into the pressurized cell 88 to convert the pressurized cell 88 into a reaction chamber. The selected gas can be reactive with interferer type ions that are present in the ion beam. The reactive gas can undergo a chemical reaction with the interferer type ions to generate product ions, which can then be filtered by applying mass-resolving RF/DC voltages to the quadrupole 80 to form a passband around the analyte ions but not the product ions. Exit lens 94 of the pressurized cell 88 can also be provided with a DC offset potential to provide ion trapping in the pressurized cell 88.

Third mass analytical quadrupole 82 can be operated as a scanning RF/DC quadrupole, or as a quadrupole ion trap, by providing a suitable RF quadrupolar confinement field and establishing a DC potential barrier at the exit lens 96 of the mass analyzer 54. As should be appreciated, different approaches can be used to mass-selectively scan (i.e. eject) ions trapped in the quadrupole 82 to the detector 58 for mass-differentiated detection. In one approach, a low-voltage auxiliary AC field can be applied to the exit lens 96, which can interact with the fringing field already formed in the vicinity of the exit lens 96 due to interaction between the RF confinement field and the DC potential barrier. As one or more parameters of the auxiliary AC voltage (magnitude, frequency) are scanned, ions of different m/z ratios can be sequentially energized due to secular coupling with the fringing field so as to overcome the exit barrier. Alternatively, the auxiliary AC field can be held constant, and one or more parameters of the RF confinement field can be scanned. As explained in more detail below, the scanning rate of ions (in units of Da/s) can be related to the step size (Da) and dwell time (s) of the auxiliary AC field or RF confinement field. This technique has been referred to as mass selective axial ejection (MSAE) and is described in more detail in U.S. Pat. No. 7,177,668, hereby incorporated by reference.

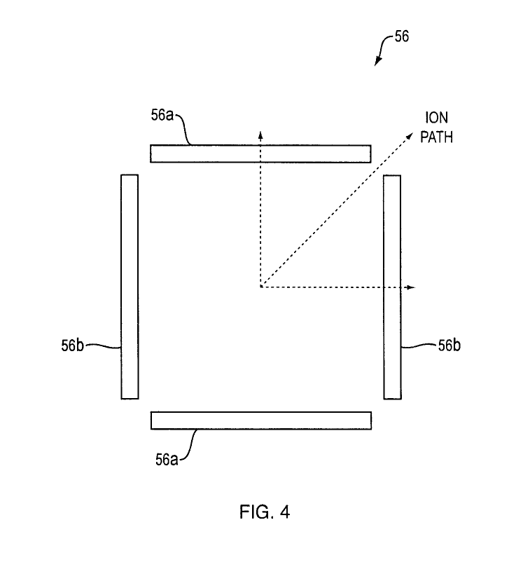

Referring now to FIG. 4, auxiliary electrodes 56 can be situated in the extraction region of the mass spectrometer 50 between the mass analyzer 54 and the detector 58, downstream of the mass analyzer 54. The auxiliary electrodes 56 can comprise a set of four plates arranged in a quadrupolar configuration to form a transmission window for the ion beam oriented generally orthogonal to the trajectory of the ion beam. In some embodiments, the auxiliary electrodes 56 can comprise a generally horizontal pair of parallel plates 56a and a generally vertical pair of parallel plates 56b, so that from the perspective of the incident ion beam, the auxiliary electrodes 56 form a rectangular transmission window. Ions received into the mass analyzer 54 can therefore be transmitted sequentially through exit lens 96 and auxiliary electrodes 56 on the way to the detector 58. It should be appreciated, however, that other orientations and configurations of the auxiliary electrodes 56 are possible as well. For example, it is not necessary to provide generally horizontal and vertical pairs of plates 56a, 56b so long as a transmission window of suitable size and shape is defined. Plates of different cross-sectional shapes can be used as well, in some embodiments.

Referring back to FIG. 3, the auxiliary electrodes 56 can be coupled to a controllable voltage source (not shown), which can be configured to provide the auxiliary electrodes 56 with a pulsed DC voltage (i.e. a square wave pulse train). Application of the pulsed voltage to the auxiliary electrodes 56 can establish an ion attenuation field therebetween in the path of the ions during time intervals in which the applied voltage is at a high level. Correspondingly, during time intervals in which a low voltage level is applied to the auxiliary electrodes 56, the resulting field, if any, can be of sufficiently low amplitude as to cause no appreciable attenuation of ion beam intensity. One or more of the fundamental frequency/period, amplitude and duty cycle of the applied pulse train can be controllable using control module 98, also included in the mass spectrometer system 50, to provide different amounts of attenuation. Potentially other types of waveforms could be generated by the controllable voltage source and provided to the auxiliary electrodes 56 in order to attenuate beam intensity. The auxiliary electrodes 56 represent one type of ion attenuator suitable for use in embodiments of the present invention, though it should be appreciated that other types and configurations of ion attenuators may be suitable as well.

The detector 58 can be a micro channel plate (MCP) detector formed of at least one highly resistive slab of metal with an array of tiny recesses, i.e. micro-channels, defined on a front face. Each micro-channel can be oriented at a slight angle, relative to the front face of the micro-channel plate, and can be supplied with a large bias voltage to act as a dynode electron multiplier. Ions entering into the channel can impact upon a channel sidewall and begin an electron cascade that propagates through the micro-channel, amplifying the strength of the original induction current by several orders of magnitude, potentially, depending on the operating parameters (e.g. bias voltage and channel length) of the detector 58. The electron cascades exiting from respective micro-channels can form a total ion current in the shape of a transient pulse. A metal anode or some other electronic component can be coupled to a rear face of the MCP to sense the transient pulses and generate corresponding detection signals A digital converter, such as a time to digital converter or fast transient recorder, can be coupled to the detector to receive and digitize the detection signals for processing. Alternatively, the detector 58 can be a channel electrode multiplier.

Certain limitations can be associated with ion detectors, such as detector 58. One associated limitation is that the detector 58 can become saturated if the ion count rate, or ion flux intensity, grows too large. Ion count rate refers to the rate at which the detector 58 is counting ions and can be defined as a number of detected ions per unit of time. If during operation of the mass spectrometer 50 the count rate of the detector 58 is high enough, for example when a particular kind of ion is present in a high concentration in the ion beam, the total induced ion current can cause electron depletion in the detector 58. Until the supply of electrons has been replenished, additional ions received at the detector 58 may not induce additional ion current. In this state of saturation, the detection signals generated by the detector 58 can become distorted and consequently can be misinterpreted by the digital converter coupled to the detector 58 or other downstream processing elements. For example, if the digital converter is a time to digital converter, the transient pulses generated by the saturated detector 58 may fall below the discriminator threshold of the time to digital converter and not trigger an ion count. Ion counts can therefore be missed altogether. Alternatively, if the digital converter is a fast transient recorder, such as an analog to digital converter, ion count can still become distorted if the transient recorder is calibrated for a certain ion response, e.g., 1.5 bins per ion. The smaller than expected transient pulses generated by the saturated detector 58 on account of electron depletion can appear as a lower ion count than is actually present at the detector plates. In either case, on a mass spectrograph, electron depletion can appear as a sudden and/or brief dip (or “valley”) in a mass peak that should not be there. It can take some time for the electron supply in the detector 58 to be replenished.

Saturation of the detector 58 can impose an effective limit on its dynamic range if, due to saturation, the detector 58 is unable to accurately measure ion flux intensities above an upper intensity detection threshold of the detector 58. Depending on how detector saturation is characterized, the upper intensity detection threshold of the detector 58 can potentially be defined in different ways. As mentioned, one way to increase the dynamic range of the detector 58, without necessarily changing its upper intensity detection threshold, is to attenuate the ion beam by some attenuation factor so that the ion count is brought below the upper intensity detection threshold of the detector 58. An adjusted intensity measure estimating initial ion intensity can then be reconstructed from the final ion intensity measure using knowledge of the attenuation factor. For example, depending on how the beam attenuation is provided, a reasonable estimate of initial ion intensity can be calculated through scaling of the final intensity measure by the attenuation factor.

When beam attenuation is provided upstream of the mass analytical components using, for example, voltage pulsing of a lens or other ion optical element (as illustrated in FIGS. 1, 2A and 2B), the resulting attenuation factor may be uniformly applied to ions across the entire mass spectrum of the ion beam. While this approach may avoid or reduce detector saturation by bringing the count rate of all high concentration ions within the upper intensity detection threshold of the detector 58, detector sensitivity may be compromised at the same time. As explained above, the attenuation may simultaneously push the final intensity measure of some low concentration ions below the noise threshold of the detector 58, making these low concentration ions, in effect, indistinguishable from spectral interferences in the ion beam or other sources or noise in the mass spectrometer 50, such as noise on the detector plates or channels. Thus, in addition to undesirable mass discriminatory effects, lens pulsing can also negatively impact on the sensitivity of the detector 58 to ions.

By situating the auxiliary electrodes 56 in the extraction region of the mass spectrometer 50, downstream of the mass analyzer 54, mass differentiation can be performed prior to ion beam attenuation. Consequently, the auxiliary electrodes 56 can operate on individual streams of different kinds of ions transmitted sequentially from the mass analyzer 54, as opposed to a homogenized ion beam that includes respective concentrations each different ion population. By attenuating separate ion streams, mass discriminatory effects can be avoided or made negligible because the ion beam has already been mass analyzed and axial spreading is therefore less severe or eliminated altogether. Moreover, different kinds of ions can be selectively targeted for attenuation by different amounts, unlike the case of homogenized beam attenuation where a single attenuation factor is selected and applied to the entire mass spectrum of the ion beam. With the added degrees of control, high concentration kinds of ions that would have saturated the detector 58 can be selectively attenuated, potentially even by different attenuation factors, and which are computed either offline or in real time. At the same time low concentration kinds of ions can be transmitted unattenuated to the detector 58 so as not to adversely impact on the effective sensitivity of the detector 58. Dynamic range can thereby effectively be extended without necessarily having to sacrifice sensitivity.

To illustrate, ion source 52 can generate an ion beam that is made up of a plurality of different kinds of ions. (As used herein, it should be understand that the term “kind of ion” can include a population of one or more individual ions of a given kind.) The plurality of different kinds of ions can be defined in different ways. For example, the different kinds of ion can be defined according to molecular composition. Thus, ⁵⁶Fe⁺ ions of ion and ⁸⁰Se⁺ ions of selenium can represent two different kinds of ions. Alternatively, the different kinds of ions can be defined according to mass to charge ratio so that each kind of ions has a substantially different m/z ratio from other kinds of ions in the ion beam. In this case, ⁵⁶Fe⁺ ions of ion and ⁴⁰Ar¹⁶O⁺ ions of argon oxide can be the same “kind” of ion because, despite their different molecular compositions, these two ions can have equal or approximately equal m/z ratios of 56.

After extraction by the sampler plate 60 and skimmer 62, the ion beam can be received into the mass analyzer 54. As described above, the mass analytical quadrupoles 78, 80 and 82 can be configured, depending on the particular MS application, for mass dependent processing of the received ion beam. Accordingly, the mass analyzer 54 can be operable to transmit the different kinds of ions present in the ion beam to the detector 58 as respective streams of those kinds of ion, in some cases separated in time according to m/z ratio, for mass-differentiated detection. Of course, it should be appreciated that some level of spectral interference could be present in these streams of different ions as well. Thus, the streams of ions may not necessarily include just ions of those respective kinds.

To transmit the different kinds of ions to the detector 58 as respective streams, the quadrupole 82 can be configured as described herein for mass-selective axial ejection, with the different streams of ions being generated sequentially during scanning of the applied auxiliary AC or RF confinement fields. In this way, the mass analyzer 54 can transmit the plurality of kinds of ions to the detector 58 as respective streams of ions during a corresponding plurality of distinct time intervals. The durations of each distinct time interval can depend on, among other parameters, the scanning rate and step size of the quadrupole 82 and the m/z ratio of a particular kind of ion, and need not all be equal. In some embodiments, the duration of each distinct time interval can equal the corresponding dwell time of the quadrupole 82 for a particular kind of ion, as will be explained further below. Moreover, it should be appreciated that, as the ion beam may only have appreciable spectral content at a set of discrete m/z ratios (determined by the particular ion populations generated by ionization of the test substance), the plurality of distinct time intervals in which respective streams of ions are transmitted to the detector 58 may also not be contiguous in time. The time intervals instead can act as a form of windowing function around the spectral content of the ion beam, which can be used in the controlled operation of the auxiliary electrodes 56.

The respective streams of each kind of ion can be transmitted from the mass analyzer 54 to the detector 58 intermediately by way of the auxiliary electrodes 56. In other words, the auxiliary electrodes 58 can be situated in the path of the ions transmitted to the detector 58 from the mass analyzer 54. Under instruction by the control module 98, therefore, the attenuation field can be formed between the auxiliary electrodes 56 to attenuate a stream of ions directed between the auxiliary electrodes 56. Alternatively, the control module 98 can instruct the auxiliary electrodes 56 to drop the attenuation field so that streams of ions may be transmitted through to the detector 58 unattenuated.

In some embodiments, the mass spectrometer 50 can further include one or more ion deflectors to establish an ion detour path, from the mass analyzer 54 to the detector 58, which avoids the auxiliary electrodes 56 altogether. In other words, ions following the ion detour path would not be directed between the auxiliary electrodes 56 where the stream of ions could be exposed to an attenuation field established by the auxiliary electrodes 56. Ions following the ion detour path can be transmitted to the detector 58 as unattenuated streams of ions. A DC quadrupole rod set oriented orthogonal to the trajectory of the ion beam, and supplied with suitable voltages to establish a deflection field, can be used to implement each one or more ion deflector. Ions can be selectively diverted along the ion detour path by controlling the timing of when the deflection field is raised and lowered to coincide with the particular kinds of ions selected for diversion.

Control module 98 can be linked to the mass analyzer 54 and the auxiliary electrodes 56 in order to provide joint control over the timing sequences executed by these two elements. Accordingly, the control module 98 can be configured to provide signals to the voltage source supplying mass analytical quadrupole 82 in order to control scanning sequences used for ejecting the ions trapped in the mass analytical quadrupole 82. In coordinated fashion, control module 98 can then also provide signals to the voltage source supplying the auxiliary electrodes 56 in order to control formation of the attenuation field between the auxiliary electrodes 56 to be time synchronized with the scanning of ions. Without limitation, the control module 98 can be configured to control the strength, frequency and duty cycle of the applied attenuation field, when the attenuation field is raised and lowered, whether or not an attenuation field is to be provided at all, and the like, based upon the kind of ion being transmitted to the detector 58. Likewise the control module 98 can be configured to control start and/or stop times of the ion scanning, mass rate of scanning, step size, dwell time, and the like.

To provide coordinated control of the mass analyzer 54 and auxiliary electrodes 56, the control module 98 can also be linked to the detector 58, as shown in FIG. 3. Alternatively the control module 98 could be linked to a digital converter module coupled to the detector 58 for sampling and digitizing the detection signals. The linkage between the control module 98 and the detector 58 can be established so that ion intensity information determined by the detector 58 can be used as a control variable by the control module 98. As an example, the detector 58 can thereby indicate to the control module 98 when the intensity of the ion beam is approaching, or perhaps has already exceeded, the upper intensity detection threshold of the detector 58. This can involve monitoring the ion count rate of the detector 58 in relation the saturation limit of the detector 58 or some maximum allowable ion count rate.

Based on the current state of the detector 58, the control module 58 can identify high concentration ions and low concentration ions in the ion beam, as well as determine which kinds of ions to attenuate and by what corresponding attenuation factor in order to prevent or reduce the impact of saturation in the detector 58. The control module 98 can pre-determine the corresponding attenuation factors for the high concentration kinds of ions ahead of ion extraction(s) in an offline setting, so that during the ion extraction(s) the control module 98 simply causes the auxiliary electrodes 56 to apply the corresponding pre-computed attenuation factors to each high concentration kinds of ions. However, assuming minimum speed requirements are satisfied, the control module 98 can also determine the corresponding attenuation factors and control attenuation levels in the auxiliary electrodes 56 in real time, during the ion extraction(s). For example, the control module 98 can monitor saturation levels in the detector 58 and then, using a form of feedback loop, modulate the attenuation level in the auxiliary electrodes 56 to control saturation levels in the detector 58. Accordingly, a fast processor and associated memory can be included in the control module 98 for this purpose. One or more data buffers and/or other signal processing components can also be utilized in the control module 98, as will be appreciated, to satisfy speed requirements.

By monitoring the current state of the detector 58 and controlling (or at least monitoring) the scanning of ions from the third mass analytical quadrupole 82, the control module 98 can then selectively configure the voltage provided to the auxiliary electrodes 56 to provide ion beam attenuation that is specific to each particular kind of ions present in the ion beam. Selective ion beam attenuation can thereby be achieved using the joint control scheme executed by control module 98, as will be explained more fully herein below.

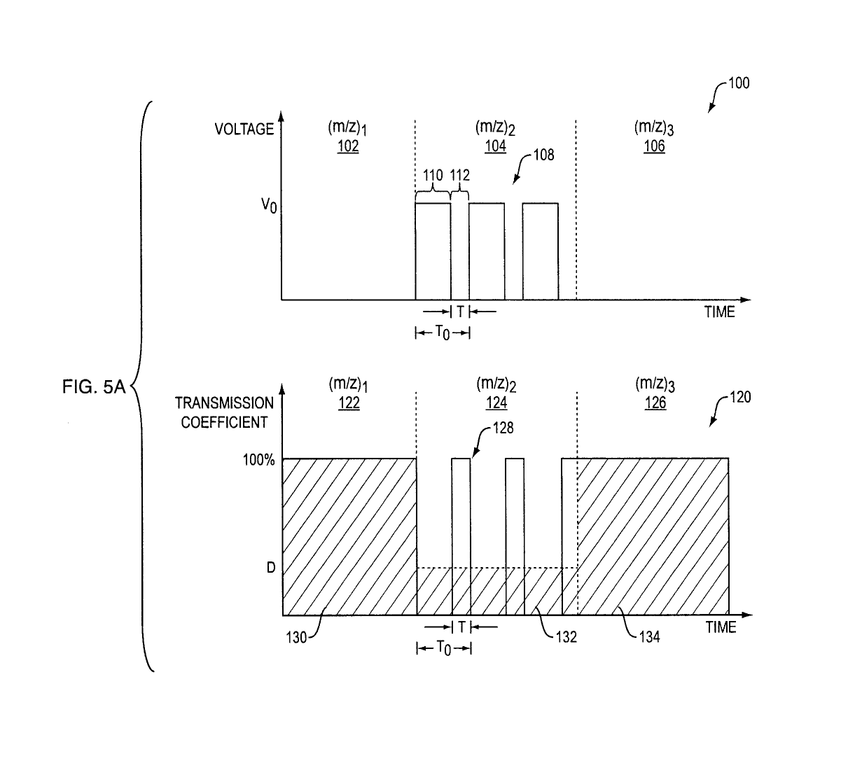

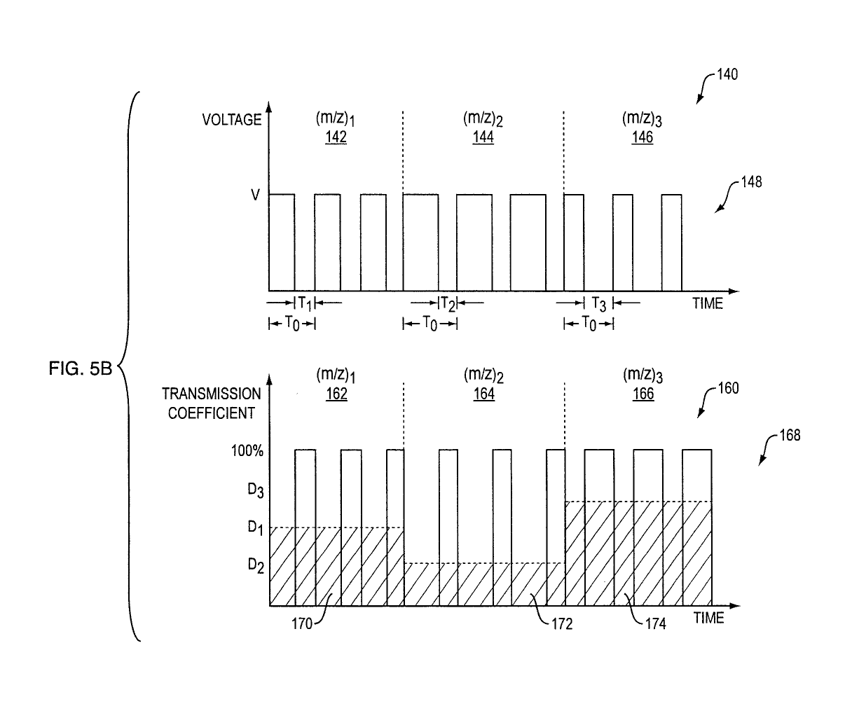

Referring now to FIGS. 5A and 5B, there are illustrated aspects of selective ion beam attenuation using the mass spectrometer system 50, in accordance with embodiments of the present invention. Graph 100 in FIG. 5A plots the instantaneous voltage (V) applied to the auxiliary electrodes 56 as a function of time, and is divided into distinct time intervals 102, 104 and 106. Distinct time interval 102 can correspond to an interval of time in which a corresponding stream of a first kind of ions is transmitted from the mass analyzer 54 to the detector 58. In the same way, distinct time interval 104 can correspond to a stream of a second kind of ions different from the first kind of ions, and distinct time interval 106 can correspond to a stream of a third different kind of ion different still from the other two kinds of ions. For example, the different kinds of ions can be ions of correspondingly different m/z ratios and the time intervals 102, 104 and 106 can represent the dwell time of the scanning quadrupole 82 at the respective m/z ratios of each correspondingly different kind of ion. Graph 100 could also be generalized, it will be noted, to include an arbitrary plurality of distinct time intervals for a corresponding plurality of different kinds of ions, but for simplicity shows only three such time intervals.

Waveform 108 represents the voltage applied to auxiliary electrodes 56 and can have a different shape in each distinct time interval. For example, the waveform 108 can be a square wave pulse train, as shown in graph 100, during time interval 104 and zero-valued during other time intervals 102 and 106. During time interval 104, waveform 108 can be defined, for each fundamental period of length T₀, by a high voltage period 110 and a low voltage period 112. The high voltage level represented by V₀ can be any appropriate voltage for providing ion beam attenuation and can depend on the inter-electrode separation in the auxiliary electrodes 56, so that an attenuation field of a suitable magnitude is created between the auxiliary electrodes 56 during operation. The low voltage level can be at or near ground potential. If the duration of the low voltage period 112 is T, then waveform 108 can have a duty cycle, D, which is equal to the ratio T/T₀, as is conventional. Waveform 108 can otherwise be zero valued during time intervals 102 and 106. It should also be appreciated that the fundamental period T₀ of waveform 108 can be very short relative to the length of the time interval 104, and that waveform 108 is shown including three full cycles during time interval 104 for illustrative purposes only.

Graph 120 in FIG. 5A plots the transmissivity of the auxiliary electrodes 56 to ions as a function of time, and can be defined on the same timescale as graph 100. Graph 102 can thus be divided up into distinct time intervals 122, 124 and 126 corresponding to time intervals 102, 104 and 106 in graph 100. The amplitude of curve 128 at any point in time on the graph 100 shows the instantaneous transmissivity of the auxiliary electrodes 56, i.e., the efficiency with which the corresponding stream of ions is transmitted through the auxiliary electrodes 56. Curve 128 oscillates between essentially zero transmission of ions when the auxiliary electrodes 58 are energized by the attenuating voltage, and essentially total transmission of ions when not energized, because almost all ions that encounter the attenuation field can be destabilized before reaching the detector 58. As the attenuation field is pulsed (according to the duty cycle of the applied voltage) during the time interval 104, some of the ions in the stream of ions can be transmitted through to the detector 58 while other of the ions will be destabilized before reaching the detector 58. The result can be some overall beam attenuation by reducing the total number of ions that reach the detector 58.

As FIG. 5A illustrates, by controlling the time intervals in which the attenuation field is formed, a particular kind of ion (in this case the second kind of ions) can be selected for attenuation. On the other hand, no appreciable beam attenuation need occur during the during the time intervals 102 and 106 when the auxiliary electrodes 56 are maintained at the low voltage level. The stream of the second kind of ion can be attenuated in the auxiliary electrodes 56, while unattenuated streams of the first and third kinds of ions can be transmitted to the detector 58. FIG. 5A shows the second kind of ions being attenuated for illustrative purposes only, and could in general show any kind of ions in the ion beam being attenuated.

Assuming that the stream of the second kind of ions has a more or less constant intensity over the entire time interval 104, an estimate of the attenuation factor applied by the auxiliary electrodes 56 can be determined by calculating final ion intensity at the detector 58 according to:

$$\hat{I} = \frac{1}{{T}_{0}} {\int }_{〈 {T}_{0} 〉} I ( t ) d t = \frac{T}{{T}_{0}} {I}_{0} = D \cdot {I}_{0} , \qquad ( 3 )$$

where Î represents the average intensity of the stream of ions measured at the detector 58 (i.e., the final intensity measure), I(t) represents the instantaneous intensity of the stream of ions measured at the detector 58, and I₀ represents the initial intensity of the stream of ions incident on the auxiliary electrodes 56 (i.e., the initial intensity measure). As before D represents the duty cycle of the applied voltage waveform 108. According to Eq.3, the final intensity measure of the ion stream can equal the initial intensity measure of the ion stream scaled by the duty cycle of the applied voltage waveform 108. In that case, the average transmissivity of the auxiliary electrodes 56 can equal the duty cycle, D, while the attenuation factor applied by the auxiliary electrodes 56 can be the inverse of the duty cycle, 1/D.

The final intensity measure of the stream of ions can be controlled between 0 and I₀ by varying the duty cycle, D, of the attenuation voltage waveform 108 between 0 and 1. One potential limitation on the accuracy of the controlled attenuation, already mentioned, is that the initial ion beam intensity should be roughly constant over the duration of the time interval 104. A sufficiently fast fundamental switching frequency of the waveform 108, corresponding to a relatively short period T₀ in comparison to the length of the time interval 104, can contribute to the accuracy of the attenuation estimate. By switching the attenuation voltage waveform 108 at a sufficiently fast rate, relative to the duration of the time interval 104, the axial location of the individual ions in the stream of ions, relative to the auxiliary electrodes 58, can be essentially uncorrelated with the present level (high or low) of the applied attenuation voltage. When that condition holds, the number of ions destabilized in the attenuation field can be essentially proportionate to the time duration of the high voltage level, and Eq. 3 can therefore provide a good estimate of final ion intensity measure. However, if the attenuation voltage applied to the auxiliary electrodes 56 is not switched fast enough, then ions could disproportionately cluster in the auxiliary electrodes 56 during one or the other of periods 110 and 112, with the result that Eq. 3 may no longer provide a good estimate. From the perspective of the applied attenuation field, the spatial distribution of the stream of ions should appear uncorrelated.

In some embodiments, the pulse frequency of the applied attenuation voltage can be related to the dwell time used during scanning of ions in the mass analyzer 54. For example, the quadrupole 82 can be mass selectively scanned by setting the quadrupole 82, for a period of time referred to as the “dwell time”, to be operable to eject ions of a certain corresponding m/z ratio. Each ion counted during a given dwell time can be assigned, in the final mass spectrum, to the corresponding m/z ratio at which the quadrupole 82 was sitting during the dwell time. At the end of one dwell time, the quadrupole 82 can be reconfigured to eject ions one step size larger during a subsequent dwell time. For example, the auxiliary AC voltage or RF confinement voltage applied to the quadrupole 82 can be stepped by a level calculated to translate the quadrupole 82 through the desired step size of ions. The scanning rate of the quadrupole 82 can then be related to dwell time and step size according to

$$scan rate = \frac{step size}{dwell time} , \qquad ( 4 )$$

where step size has units of Daltons (Da), dwell time has units of seconds (s), and scan rate has units of Da/s. Ion beam attenuation can be confined within a given dwell period

Subject to limitation as explained more below, the pulse frequency of the applied attenuation voltage can equal the inverse of the dwell time, which would correspond to the period T₀ equaling the time interval 104 in FIG. 5A. Some example values are provided in the tables below for quad mode and trap mode operation of the quadrupole 82, respectively.

TABLE I
Example Attenuation Frequencies for Quad Mode Operation

| Scan Rate | Step Size | Dwell Time | Pulse Freq. |
|---|---|---|---|
| (Da/s) | (Da) | (μs) | (Hz) |
| 10 | 0.1 | 10000 | 100 |
| 200 | 0.1 | 500 | 2000 |
| 1000 | 0.1 | 100 | 10000 |
| 2000 | 0.1 | 50 | 20000 |
| 12000 | 0.1 | 8.33 | 120000 |

TABLE II
Example Attenuation Frequencies for Trap Mode Operation

| Scan Rate | Step Size | Dwell Time | Pulse Freq. |
|---|---|---|---|
| (Da/s) | (Da) | (μs) | (Hz) |
| 50 | 0.01 | 200 | 5000 |
| 250 | 0.02 | 80 | 12500 |
| 1000 | 0.05 | 50 | 20000 |
| 10000 | 0.12 | 12 | 83333.33 |
| 20000 | 0.12 | 6 | 166666.67 |

It can be seen from the above two tables that the attenuation pulse frequencies can range from as low as 100 Hz at a 10 Da/s scan rate (quad mode) to as high as 166.7 kHz at 20,000 Dais (trap mode). However, it should be appreciated that these numbers are provided for exemplary purposes only, and that other pulse frequencies may be possible as well in alternative embodiments. Setting the pulse frequency equal to the inverse of dwell time can represent a theoretical lower limit on a range of available pulse frequencies, which, due to one or more limitations, may be higher than the theoretical limit. For example, both the saturation limit of the detector 58 and intensity of the ion beam can impose limitations on the applied pulse frequency.

The saturation limit of the detector 58 can effectively impose a maximum time limit during which the detector 58 can receive an unattenuated stream of ions of a certain ion intensity before the onset of saturation. The pulse frequency of the applied attenuation voltage can be selected to prevent the detector 58 from receiving a stream of ions that would drive it into saturation. In some cases, the required pulse frequency can be much higher than the inverse of the dwell time selected for the quadrupole 82. As an example, a scan rate of 10 Da/s and step size of 0.1 Da corresponds to a calculated dwell time of 10 000 microseconds and a minimum attenuation frequency of 100 Hz. However, if the detector 58 begins to saturate for a given intensity of ions after only 100 microseconds, then an attenuation frequency of 100 Hz may result in the detector 58 becoming saturated. As a result, an attenuation frequency of at least the inverse of the saturation time (100 microseconds) can be selected, which in this example would be 10 000 Hz and not the 100 Hz shown in Table I.

The travel time of ions through the auxiliary electrodes 56 can provide another limitation on attenuation pulse frequency. If it can be assumed that the auxiliary electrodes 56 have some finite gate length, then individual ions in the ion beam can require some corresponding finite amount of time to pass through the auxiliary electrodes 56. The pulse frequency and duty cycle of the applied attenuation field can be jointly selected so that individual ions are afforded sufficient time to clear the auxiliary electrodes 56 during times when the attenuation field is off. Total ion beam attenuation can result if the off time of the attenuation field is less than the effective travel time of ions through the auxiliary electrodes 56, i.e., because the time between the attenuation field being lowered and raised again would not be long enough for individual ions to pass through. As noted above, the travel time of an ion through the auxiliary electrodes 56 can also be related to the m/z charge ratio of the ion, with heavier ions having generally slower particle velocities and lighter ions having generally faster particle velocities.

As an example, assume the effective gate length of the auxiliary electrodes 56 is 5 mm and that a 2000 Da ion is traveling through the gate with about 200 eV of energy. The effective time this ion will spend in the gate region of the auxiliary electrodes 56 is approximately 1.14 microseconds. If the off time of the applied attenuation field is shorter than 1.14 microseconds, then total ion beam attenuation may occur because no appreciable number of ions can completely traverse the gate before the attenuation field is raised again. No signal would then be measured at the detector 58. This situation could potentially occur for high scan rates. According to Table II above, a scan rate of 20 000 Da/s and a step size of 0.12 Da corresponds to a dwell time of 6 microseconds and an attenuation pulse frequency of 166.7 kHz. For the 2000 Da ion at 200 eV to traverse the effective 5 mm gate, the auxiliary electrodes 56 can be set to transmit for at least 1.14 microseconds, which corresponds to a duty cycle of at least 19% (1.14/6*100). Duty cycles of about 19% or less would produce no appreciable signal at the detector 58. Of course, it should be appreciated that a different threshold duty cycle could result if the pulse frequency were varied.

Now assume that the ion has a mass of about 50 Da. If all other parameters remain unchanged, the travel time of the lighter 50 Da ion through the gate will be about 0.18 microseconds (as opposed to 1.14 microseconds). Applying the same attenuation field (166.7 kHz, 19% duty cycle) to the auxiliary electrodes 56, instead of no detected signal, the final intensity measure of the lighter 50 Da ion at the detector 58 can be about 19% of its initial intensity measure. In contrast to the heavier 2000 Da ion, the time required by the lighter 50 Da ion to traverse the gate is much shorter than the off time interval, given by the duty cycle and pulse frequency of the applied attenuation field, when the auxiliary electrodes 56 are transmitting ions. Assuming a substantially uncorrelated distribution of ions, the effective attenuation factor applied by the auxiliary electrodes 56 can then approximately equal the duty cycle of the attenuation field, as described above. Transmitting ions through the auxiliary electrodes 58 with higher energies (corresponding to faster particle velocities or shorter travel times) can also reduce this effect.

The overlaid shaded regions in graph 120 represent the average ion transmissivity of the auxiliary electrodes 58 for the different time intervals. Regions 130 and 134 indicate complete transmission during time intervals 122 and 126 where no ion beam attenuation was requested. Region 132 indicates attenuation of the ion beam during time interval 124 when the voltage waveform 108 was applied to the beam chopping electrodes 58. As given by Eq. 3, the average transmissivity is approximately, D, the duty cycle of the applied waveform 108. When the attenuation voltage is switched fast enough, a stream of ions of the initial intensity chopped up by the auxiliary electrodes 56 into a pseudo-continuous stream, from the perspective of the detector 58, can appear indistinguishable from a continuous stream of ions of the final intensity. This can be the case in so far as the two different streams have the same overall average intensity. The attenuation factor can be controllable according to the duty cycle of the applied attenuation voltage, and the attenuation field can be applied selectively to streams of different kinds of ion by controlling the time intervals in which the auxiliary electrodes 58 are energized.

Referring now to FIG. 5B specifically, graph 140 plots the instantaneous voltage (V) applied to the auxiliary electrodes 56 as a function of time for a different mode of operation of the auxiliary electrodes 56 as shown in FIG. 5A. Graph 140 is divided into distinct time intervals 142, 144 and 146, which again can correspond to distinct intervals of time in which a corresponding stream of a different kind of ions can be transmitted from the mass analyzer 54 to the detector 58 for mass-differentiated detection. Waveform 148 again can represent the instantaneous voltage applied to auxiliary electrodes 56, and can be a square wave pulse train, this time defined by a different duty cycle for each distinct time interval 142, 144 and 146. Given a fundamental period of length T₀, which can be selected subject to the limitations described above, waveform 148 can have a duty cycle equal to T₁/T₀ in time interval 142, equal to T₂/T₀ in time interval 144 and equal to T₃/T₀ in time interval 146. The duty cycle of a particular time interval can be selected independent of other time intervals. Accordingly, in the applied waveform 148, the duty cycle of a particular time interval can be different from the duty cycle of one or more other time intervals. In general, there can be a plurality of different duty cycles corresponding to the plurality of different time intervals. As shown in FIG. 5B, and for illustrative purposes only, the duty cycle of waveform 148 is approximately 50% in time interval 142, approximately 33% in time interval 144, and approximately 67% in time interval 146. As a result, a different attenuation factor can be applied to each different stream of ions of a different kind.

Graph 160 in FIG. 5B again plots the transmissivity of the auxiliary electrodes 56 to ions as a function of time, and can be defined on the same timescale as graph 140. Graph 160 can thus be divided up into distinct time intervals 162, 164 and 166 corresponding to time intervals 142, 144 and 146 in graph 140. The amplitude of curve 168 at any point in time on the graph 160 again shows the approximate instantaneous transmissivity of the auxiliary electrodes 56. Shaded overlaid regions 170, 172 and 174 show corresponding average transmissitivies for the different time intervals. It is evident from the different shaded regions 170, 172 and 174 in FIG. 5B that the duty cycle of the applied voltage waveform 148 can provide a control variable for ion transmissivity.

For example, under the control of the control module 98, the duty cycle of the voltage applied to auxiliary electrodes 56 can be varied so that the auxiliary electrodes 56 attenuate a stream of one kind of ions by a selected attenuation factor, while attenuating a stream of another kind of ions by a different attenuation factor. The associated detection signal generated by the detector 58 for that kind of ion could thereby be attenuated also by the selected attenuation factor. More generally, for each of a plurality of different kinds of ions in the ion beam, a different attenuation factor can be determined and the auxiliary electrodes 56 can attenuate the stream of that kind of ions by a different selected attenuation factor (one factor corresponding to each kind of ion). Each different attenuation factor can be set by a correspondingly different duty cycle of the voltage waveform applied to the auxiliary electrodes 56 during the corresponding time interval in which the stream of that kind of ions is transmitted. Attenuating the respective streams of ions being transmitted to the detector 58 can in turn cause attenuation of the associated detection signal for that kind of ion. For example, one or more associated detection signals can be attenuated to avoid saturation of the detector 58.

The decision whether or not to attenuate a particular kind of ions, as well as the corresponding attenuation factor, can be made by the control module 98 depending on the concentration of that kind of ion in the ion beam and an upper intensity detection threshold of the detector 58. For example, the upper intensity detection threshold can be or can be defined in relation to a saturation limit of the detector 58. If the concentration of a particular kind of ion is high enough that an unattenuated stream of kind of ion would saturate the detector 58, then the control module 98 can configure the auxiliary electrodes 56 for selective attenuation of that kind of ion to bring the concentration of that kind of ion within the upper intensity threshold of the detector 58. On the other hand, if the concentration of a particular kind of ion is low enough that the detector 58 would not saturate, then the control module 98 can configure the auxiliary electrodes 56 to pass the stream of that kind of ions unattenuated to the detector 58. Of course, some ion beam attenuation could be applied even to the low concentration kinds of ions, if desired, but doing so could effectively reduce the sensitivity of the detector 58 without necessarily increasing its dynamic range.

The linkage between the control module 98 and the detector 58 allows the control module 98 to receive and process ion intensity information, such as ion count rate, which is generated by the detector 58. For example, the processor of the control module 98 can be configured to compare the ion count rate against the upper intensity detection threshold of the detector 58 in order to characterize the intensity of each particular kind of ion in the ion beam as either a high concentration type of ion or a low concentration type of ion. The high concentration kinds of ions can be those kinds of ions whose initial intensity measured at the detector would exceed the upper intensity detection threshold of the detector 58. Conversely the low concentration kinds of ions can be those kinds of ions whose initial intensity measured at the detector is below the upper intensity detection threshold of the detector 58. Thus, the control module 98 can be configured to identify those kinds of ions present in the ion beam that could potentially drive the detector 58 above its upper intensity detection threshold if left unattenuated.

The control module 98 can make the determination of high and low concentration ions according to different approaches. According to one possible approach already mentioned, the control module 98 can compare the ion count rate of the detector 58 against the upper intensity detection threshold of the detector 58, in the form of a maximum allowable count rate or saturation limit. The maximum allowable count rate can be pre-determined for the detector 58 to reflect the range of ion flux intensities that would be expected to drive the detector 58 into saturation. In other words, saturation would be a likely outcome if the detector 58 were subject to count rates above the maximum allowable count rate for any prolonged period of time. By testing the monitored count rate of the detector 58 against the maximum count rate, the control module 98 can observe the m/z ratio of the kind of ion that drove the ion detector 58 above its upper intensity detection threshold and characterize that kind of ion as a high concentration kind of ion. Other kinds of ions generating ion count rates below the maximum allowable count rate could likewise be characterized by the control module 98 as low concentration kinds of ions.

According to another possible approach, a maximum measure ion flux intensity of the detector can be pre-determined and used as the upper intensity detection threshold of the detector 58. For example, the detector 58 can be tested offline in order to ascertain the maximum measurable ion flux intensity for different operating conditions of the detector 58, such as ion extraction rate, scan rate and/or detector sampling rate. To some extent, therefore, the maximum measurable ion flux intensity can be related at least implicitly to ion count rate. The control module 98 can then process the detection signals generated by the detector 58 to determine if the upper intensity detection threshold of the detector 58 has been exceeded. Again, if so, the control module 98 can identify the kind of ion responsible for saturation of the detector 58, and characterize that kind of ion has a high concentration kind of ions. All other ions in the ion beam can be characterized as low concentration kinds of ions by the control module 98. Other approaches to identifying the high and low concentration kinds of ions may be possible as well.

The control module 98 can also generate control signals for the auxiliary electrodes 58 according to different approaches. In some embodiments, the control module 98 can pre-determine the high and low concentration kinds of ions present in the ion beam, as well as corresponding attenuation factors for each high concentration kind of ions. These determinations could be made in an offline analysis or with prior knowledge of the test substance. For example, during a test ion extraction, the corresponding attenuation factors applied to each high concentration kind of ion can be adjusted until a suitable ion count rate is observed at the detector 58. Having determined suitable attenuation factors for the different high concentration kinds of ions, later during actual ion extraction(s), the control module 98 could then jointly control the mass analyzer 54 and auxiliary electrodes 56 so that attenuation field of the pre-determined attenuation factors can be applied during time intervals corresponding to transmission of the high concentration kinds of ions to the detector 58. The offline test can allow the control module 98 to effectively anticipate and prevent detector saturation. As a result, the detection signals associated with those high concentration kinds of ions can also be attenuated by corresponding attenuation factors. Control module 98 can also jointly control the mass analyzer 54 and auxiliary electrodes 56 to transmit each low concentration kind of ion as an unattenuated stream of those kinds of ions. This approach is illustrated, for example, in FIGS. 5A and 5B, in which the corresponding time intervals and attenuation factors are known ahead of time.

The processor of the control module 98 can also be configured to determine an adjusted intensity measure for each high concentration kind of ion attenuated in the auxiliary electrodes 56. The adjusted intensity measure for a particular kind of ion can be, in effect, an estimate of that ion's initial ion intensity before attenuation. The adjusted intensity measure can also therefore represent the intensity measure that the detector 58 would have measured if not for the upper intensity detection threshold of the detector 58 having been exceeded. To a reasonable degree of accuracy, the control module 98 can determine the adjusted intensity measure by scaling the final intensity measure for a particular ion by the corresponding attenuation factor applied to the stream of that particular ion in the auxiliary electrodes 56. For increased accuracy, more variables or parameters can be taken into consideration in calculating the adjusted intensity measures.

According to a different approach, however, the control module 98 can also determine attenuation factors, and corresponding control signals for the auxiliary electrodes 56, dynamically and in real time during individual ion extractions. In this approach, the control module 98 can initially configure the auxiliary electrodes 56 to provide no ion beam attenuation as ions are scanned out of the mass analytical quadrupole 82 in mass-dependent fashion to generate and transmit streams of different kinds of ions. The control module 98 can continuously monitor the ion count rate at the detector 58 to determine if the count rate is approaching or has exceeded the maximum allowable count rate for the detector 58, which is indicative of a high concentration kind of ion causing detector saturation. When the control module 56 detects this condition, the auxiliary electrodes 56 can be supplied with an initial attenuation voltage waveform to begin attenuating the stream of that kind of ion. The initial attenuation voltage waveform can correspond to an initial pre-determined attenuation factor. For example, the initial attenuation voltage can be a square wave pulse train having a 90% duty cycle (corresponding to about 10% beam attenuation), though other values for the initial attenuation factor could be possible as well. In some cases, attenuating the high concentration kind of ion at the initial attenuator factor can bring the detector 58 back within the upper intensity detection threshold of the detector 58. The auxiliary electrodes 56 can then be held at that attenuation level by the control module 98 until the ion count rate starts to decline. Once the ion count rate has decreased enough so that the ion count rate of an unattenuated stream of ions would be below the maximum allowable count rate, the control module 98 can cause the auxiliary electrodes 56 to drop the attenuation field.

In some cases, however, the initial attenuation factor can be insufficient to avert detection saturation. Accordingly, the control module 98 can be configured to adjust the attenuation voltage applied to the auxiliary electrodes 98 from its initial value in order to increase the effective levels of ions beam attenuation. By monitoring the ion count rate at the detector 58, the control module 98 can implement a form of feedback loop that modulates the applied attenuation voltage according to a sequence of different attenuation factors calculated by the control module 98 until the ion count rate at the detector 58 stabilizes within the upper intensity detection threshold. The control module 98 can then maintain the auxiliary electrodes 56 at the final attenuation factor for as long as is required to keep the detector 58 operating within the upper intensity detection threshold. When the ion count rate begins to drop, which could occur when the mass analytical quadrupole 82 begins to transmit a stream of a low concentration kind of ion, the control module 98 can respond by decreasing the strength of the attenuation field. In this way, the auxiliary electrodes 56 can be de-energized so that the streams of different kinds of ions once again are transmitted unattenuated to the detector.

As required, the attenuation factor provided by the auxiliary electrodes 56 can be varied smoothly or abruptly (by changing the duty cycle of the applied attenuation voltage). The variable attenuation applied to a particular stream of ions can, on average, amount to an overall attenuation factor for that corresponding kind of ions, which the control module 98 can compute. In general, the control module 98 can define a transfer function between the ion count rate at the detector 58 and the applied attenuation voltage at the auxiliary electrodes 56, which is then used in a control algorithm to stabilize ion count rate. The control algorithm executed by the control module 98 can be repeated each time the count rate exceeds the upper intensity detection threshold of the detector 58.

If the auxiliary electrodes 56 are located in close enough proximity to the detector 58 (which can be a reasonable assumption when they auxiliary electrodes 56 are located in the extraction region of the mass spectrometer 50 adjacent to the detector 58), then the lag between the monitored ion count rate and modulated attenuation voltage can be kept small. Accordingly, the modulated sequence of attenuation factors implemented by the auxiliary electrodes 56 in response to ion count rate can be essentially synchronized with the sequence of final ion intensities measured at the detector 58 each as a function of time. To calculate the adjusted intensity values, the processor in the control module 98 can then scale the sequence of final intensity values piecewise by the modulated sequence of attenuation factors. If the control module 98 has a fast enough processor, this form of joint control can be executed on a per extraction basis in real time, without the need for offline testing or calibration in order to pre-compute corresponding attenuation factors for the high concentration kinds of ions. The attenuation factors are instead computed and controlled dynamically.

Although reference is primarily made to ESI (electrospray ionization) or MALDI (matrix-assisted laser desorption/ionization) mass spectrometry, it should be appreciated that the embodiments described herein, with appropriate modification, could be appropriate when other analytical techniques are used in conjunction with mass spectrometry as well. For example, the described embodiments could be useful for certain chromatographic applications. In chromatography, a mixture dissolved in a mobile phase can be passed through a stationary phase in order to separate the analyte (i.e. the test substance) from other molecules. Separation can occur due to differential interactions between the different molecules in the mixture with the stationary phase.

Liquid chromatography can be a particular type of chromatography in which the mobile phase is a liquid, as opposed to a gas, for example, and can be carried out either in a column or a plane. In high-performance liquid chromatography mass spectrometry (HPLC/MS), the liquid mixture can be forced through a column packed with irregularly or spherically shaped particles and maintained at a relatively high pressure. The flow rate of different molecules in the mixture can be different, as mentioned, due to their differential interaction with the packed particles. The liquid eluted from the liquid chromatograph column can then be transferred directly or indirectly to a suitable ion source for ionization, which can be an electrospray, microspray or nanospray ion source, for example. The ionized particle stream can then be transmitted to a mass spectrometer and detector in order to identify and quantify the relative concentrations of the different molecules present in the test mixture.

Liquid chromatography can tend to generate ion beams that have large differential concentrations of molecules, which can create the need for a detector with large dynamic range. The herein described methods for providing ion beam attenuation, it will be appreciated, can therefore be used to extend the dynamic range of the detectors used in liquid chromatography to expand its utility as an analytical technique.

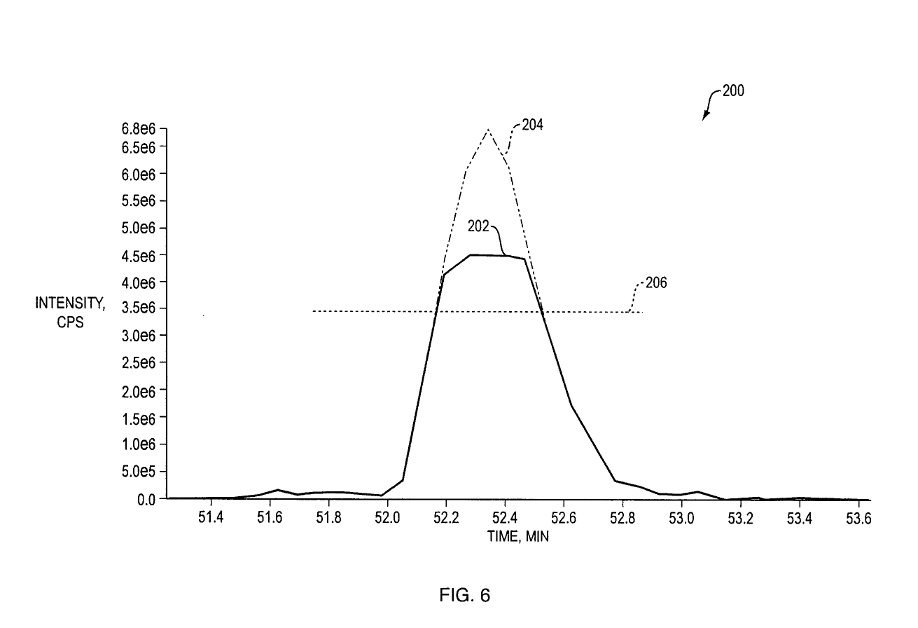

Referring now to FIG. 6, there is illustrated an example LC/MS/MS chromatogram 200 according to aspects of embodiments of the present invention. The mass chromatogram 200 can be generated, for example, by operation of the mass spectrometer 50 according to a single reaction monitoring (SRM) or multiple reaction monitoring (MRM) mode. The mass chromatogram plots elution time (min) on the x-axis against ion intensity (counts/second, cps) on the y-axis. It should be understand that the values illustrated in FIG. 6 are exemplary only. Curve 202 represents the final intensity measure of a representative high concentration kind of ion when no ion beam attenuation is applied. Curve 204 represents the adjusted intensity measure of the same high concentration kind of ion when ion beam attenuation is applied. Threshold 206 can represent the upper intensity detection threshold of the detector 56.

As can be seen from FIG. 6, curve 202 can become distorted when the detector 58 reaches its saturation level of about 4.5×10⁶ counts per second. On the other hand, curve 204 is generated using ion beam attenuation and intensity measure adjustment. The parts of curve 204 falling below threshold 206, at about 3.5×10⁶ counts per second, are generated using the final intensity measure at the detector 56 without adjustment. However, once curve 204 crosses above threshold 206, ion beam attenuation is activated, and curve 204 is then reconstructed using the final intensity measure at the detector 56 and the duty cycle of the applied attenuation field, as described herein. Once curve 204 falls below threshold 206 again, ion beam attenuation is deactivated and curve 204 again represents the final intensity measure at the detector 56, no longer adjusted using the duty cycle of the attenuation field. As can be seen, curve 204 does not show the same distortion as curve 202 due to detection saturation. Whether a pre-determined or dynamically determined attenuation factor is applied, curve 204 can be reconstructed to be substantially free of distortion. It is also noted that the threshold 206 (3.5×10⁶), as shown in FIG. 6, is defined in relation to the saturation limit (4.5×10⁶) of the detector 56, though in some embodiments, the threshold 206 can be defined differently. In some cases, the threshold 206 can approximately equal the saturation limit of the detector 56.

While the above description provides examples and specific details of various embodiments, it will be appreciated that some features and/or functions of the described embodiments admit to modification without departing from the scope of the described embodiments. The above description is intended to be illustrative of the invention, the scope of which is limited only by the language of the claims appended hereto.

1. A method of operating a mass spectrometer system, the method comprising:
a) providing a plurality of kinds of ions of different mass to charge ratios in an upstream mass analyzer;
b) transmitting the plurality of kinds of ions from the upstream mass analyzer to a detector by transmitting each kind of ions in the plurality of kinds of ions as a stream of that kind of ions;
c) detecting the plurality of kinds of ions at the detector to generate a plurality of detection signals, wherein the plurality of detection signals comprises an associated detection signal for each kind of ions in the plurality of kinds of ions; and,
d) for at least one kind of ions in the plurality of kinds of ions, attenuating the associated detection signal for that kind of ions by an attenuation factor by attenuating the stream of that kind of ions from the upstream mass analyzer to the detector to reduce a number of ions of that kind of ions reaching the detector by the attenuation factor.

2. The method as defined in claim 1, wherein b) comprises transmitting the plurality of kinds of ions during a plurality of corresponding distinct time intervals for mass-differentiated detection of the plurality of kinds of ions by the detector.

3. The method as defined in claim 2, wherein d) comprises, for at least one other kind of ions in the plurality of kinds of ions, attenuating the associated detection signal for that other kind of ions by a different attenuation factor by attenuating the stream of that other kind of ions from the upstream mass analyzer to the detector to reduce a number of ions of that other kind of ions reaching the detector by the different attenuation factor.

4. The method as defined in claim 2, wherein d) comprises, for at least one other kind of ions in the plurality of kinds of ions, transmitting that other kind of ions from the upstream mass analyzer to the detector as an unattenuated stream of that other kind of ions.

5. The method as defined in claim 2, further comprising determining a plurality of attenuation factors for the plurality of kinds of ions, wherein the plurality of attenuation factors comprises a corresponding attenuation factor for each kind of ions in the plurality of kinds of ions; and
wherein d) comprises, for each kind of ions in the plurality of kinds of ions, attenuating the associated detection signal for that kind of ions by the corresponding attenuation factor by attenuating the stream of that kind of ions from the upstream mass analyzer to the detector to reduce a number of ions of that kind of ions reaching the detector by the corresponding attenuation factor.

6. The method as defined in claim 5, wherein the plurality of attenuation factors are different from each other, such that different kinds of ions in the plurality of kinds of ions are attenuated by different attenuation factors.

7. The method as defined in claim 2, wherein
the detector has an upper intensity detection threshold;
the plurality of kinds of ions comprises a group of high concentration kinds of ions;
each high concentration kind of ions in the group of high concentration kinds of ions has a corresponding initial intensity measure at the detector exceeding the upper intensity detection threshold;
the method further comprises determining a corresponding attenuation factor for each high concentration kind of ions in the group of high concentration kinds of ions to reduce the associated detection signal for that high concentration kind of ions from the corresponding initial intensity measure to a corresponding final intensity measure, the corresponding final intensity measure being less than the upper intensity detection threshold; and,
d) comprises, for each high concentration kind of ions in the group of high concentration kinds of ions, attenuating the associated detection signal for that high concentration kind of ions by the corresponding attenuation factor by attenuating the stream of that kind of ions from the upstream mass analyzer to the detector to reduce a number of ions of that kind of ions by the attenuation factor.

8. The method as defined in claim 7, wherein
the plurality of kinds of ions further comprises a group of low concentration kinds of ions;
each low concentration kind of ions in the group of low concentration kinds of ions has a corresponding initial intensity measure at the detector below the upper intensity detection threshold; and,
d) comprises transmitting each low concentration kind of ions in the group of low concentration kinds of ions from the upstream mass analyzer to the detector as an unattenuated stream of that kind of ions.

9. The method as defined in claim 7, further comprising, for each high concentration kind of ions in the group of high concentration kinds of ions, determining a corresponding adjusted intensity measure at the detector based on the corresponding attenuation factor and the corresponding final intensity measure.

10. The method as defined in claim 9, wherein, for each high concentration kind of ions in the group of high concentration kinds of ions, determining the corresponding adjusted intensity measure comprises multiplying the corresponding attenuation factor and the corresponding final intensity measure.

11. The method as defined in claim 7, further comprising determining the upper intensity detection threshold of the detector based on a saturation limit of the detector.

12. The method as defined in claim 2, wherein d) comprises selecting at least one kind of ions for attenuation, and providing an attenuation field between the upstream mass analyzer and the detector only during the corresponding distinct time intervals for the selected at least one kind of ions.

13. The method as defined in claim 2, further comprising, for at least one kind of ion in the plurality of kinds of ions, applying variable attenuation to the stream of that kind of ions, and determining the attenuation factor for that kind of ions as an average attenuation applied to the stream of that kind of ions.

14. The method as defined in claim 2, further comprising, for at least one kind of ion in the plurality of kinds of ions, providing an attenuation field between the upstream mass analyzer and the detector, and selecting a pulse frequency of the attenuation field to be at least equal to the inverse of a dwell time of the upstream mass analyzer.

15. A mass spectrometer system comprising:
an upstream mass analyzer for receiving a plurality of kinds of ions of different mass to charge ratios, the upstream mass analyzer being operable to transmit each kind of ion in the plurality of kinds of ions from the upstream mass analyzer as a stream of that kind of ions for detection;
a detector for detecting the plurality of kinds of ions transmitted from the upstream mass analyzer to generate a plurality of detection signals, wherein the plurality of detection signals comprises an associated detection signal for each kind of ions in the plurality of kinds of ions; and,
an ion attenuator located downstream of the upstream mass analyzer and operable to, for at least one kind of ion in the plurality of kinds of ions, attenuate the associated detection signal for that kind of ions by an attenuation factor by receiving and attenuating the stream of that kind of ions from the upstream mass analyzer to the detector to reduce a number of ions of that kind of ions reaching the detector by the attenuation factor.

16. The mass spectrometer system as defined in claim 15, wherein the ion attenuator is operable to, for at least one other kind of ions in the plurality of kinds of ions, attenuate the associated detection signal for that other kind of ions by a different attenuation factor by receiving and attenuating the stream of that other kind of ions from the upstream mass analyzer to the detector to reduce a number of ions of that other kind of ions reaching the detector by the different attenuation factor.

17. The mass spectrometer system as defined in claim 15, further comprising a controller linked to the upstream mass analyzer and the ion attenuator, the controller being operable to jointly control the upstream mass analyzer to transmit the plurality of kinds of ions from the upstream mass analyzer to the detector during a plurality of corresponding distinct time intervals for mass-differentiated detection of the plurality of kinds of ions by the detector; and,
the ion attenuator to provide an attenuation field between the upstream mass analyzer and the detector only during the corresponding distinct time intervals for a selected at least one kind of ions to be attenuated.

18. The mass spectrometer system as defined in claim 17, wherein
the detector has an upper intensity detection threshold;
the controller is linked to the detector to determine, for each kind of ions, if that kind of ions is in a group of high concentration kinds of ions or a group of low concentration kinds of ions;
each high concentration kind of ions in the group of high concentration kind of ions has a corresponding initial intensity measure at the detector exceeding the upper intensity detection threshold;
the controller comprises a processor for determining a corresponding attenuation factor for each high concentration kind of ions in the group of high concentration kind of ions to reduce the associated detection signal for that high concentration kind of ions from the corresponding initial intensity measure to a corresponding final intensity measure, the corresponding final intensity measure being less than the upper intensity detection threshold; and
the controller is operable to, for each high concentration kind of ions in the group of high concentration kind of ions, control the ion attenuator to attenuate the associated detection signal for that high concentration kind of ions by the corresponding attenuation factor by attenuating the stream of that kind of ions from the upstream mass analyzer to the detector to reduce a number of ions of that kind of ions by the attenuation factor.

19. The mass spectrometer system as defined in claim 18, wherein
each low concentration kind of ions in the group of low concentration kind of ions has a corresponding initial intensity measure at the detector below the upper intensity detection threshold; and
the controller is operable to, for each low concentration kind of ions in the group of low concentration kind of ions, control the ion attenuator to transmit that kind of ion from the upstream mass analyzer to the detector as an unattenuated stream of that kind of ions.

20. The mass spectrometer system as defined in claim 19, further comprising
an ion detour path from the upstream mass analyzer to the detector, wherein the ion detour path avoids the ion attenuator, and
an ion redirecting module controllable by the controller to direct each low concentration kind of ions in the group of low concentration kind of ions from the upstream mass analyzer to the detector via the ion detour path.

21-25. (canceled)
